(19) United States
(12) Patent Application Publication
(10) Pub. No.: US 2014/0126434 A1
(43) Pub. Date: May 8, 2014

(54) METHOD AND APPARATUS FOR TRANSMITTING AND PROCESSING CONTROL INFORMATION IN TIME DIVISION DUPLEX SYSTEM USING MULTI-COMPONENT CARRIER

(71) Applicants: Jianjun Li, Seoul (KR); Kyoungmin Park, Seoul (KR)

(72) Inventors: Jianjun Li, Seoul (KR); Kyoungmin Park, Seoul (KR)

(73) Assignee: Pantech Co., Ltd., Seoul (KR)

(21) Appl. No.: 14/130,851

(22) PCT Filed: Jul. 3, 2012
(86) PCT No.: PCT/KR2012/005262

§ 371 Date: Jan. 3, 2014

(30) Foreign Application Priority Data
Jul. 4, 2011 (KR) 10-2011-0066145

(51) Int. Cl. H04L 5/00; H04L 5/14

(52) U.S. Cl. CPC H04L 5/0053; H04L 5/14
USPC 370/280

(57) ABSTRACT

Provided is a method and apparatus for scheduling subframes of two component carriers (CCs) in a time division duplex (TDD) system using a multi-CC.

### CROSS-REFERENCE TO RELATED APPLICATIONS

This application is the National Stage Entry of International Application PCT/KR2012/005262, filed on Jul. 3, 2012, and claims priority from and the benefit of Korean Patent Application No. 10-2011-0066145, filed on Jul. 4, 2011, both of which are incorporated herein by reference for all purposes as if fully set forth herein.

### BACKGROUND

1. Field

The present invention relates to a time division duplex (TDD) system using a single component carrier (CC) or a plurality of CCs.

2. Background

As communication systems have developed, various wireless terminals have been utilized by consumers, such as companies and individuals. A current mobile communication system, such as 3GPP-based long term evolution (LTE), LTE-advanced (LTE-A), and the like, is a high capacity communication system capable of transmitting and receiving various data such as image data, wireless data, and the like, beyond providing a sound-based service. Accordingly, there is a desire for a technology that transmits high capacity data, which is comparable with a wired communication network. Data may be effectively transmitted through use of a plurality of component carriers (CCs) as a high capacity data transmitting scheme.

In the scheme, a time division duplex (TDD) system that temporally distinguishes uplink (UL) transmission and downlink (DL) transmission through use of a single carrier frequency may use a predetermined frequency band for transmission and reception, and may transmit and receive data based on a time slot. In the TDD system using a plurality of CCs, when the CCs use the same TDD configuration, flexibility in data transmission and data reception in each of a UL and a DL may be deteriorated.

### SUMMARY

Accordingly, the present invention has been made to solve the above-mentioned problems occurring in the prior art, and an object of the present invention is associated with a radio communication system and is to provide a method and apparatus for scheduling subframes of two component carriers (CCs) in a time division duplex (TDD) system using a multi-CC, so as to effectively assign response control information.

In order to accomplish this object, there is provided a method of transmitting control information in a time division duplex (TDD) system, the method comprising the steps of setting TDD configuration including at least one uplink (UL) and downlink (DL) subframe, the TDD configuration corresponding to an ordering component carrier (CC) and a following CC each is set independently; and transmitting control information to a user equipment (UE) on one subframe of the ordering CC, wherein the control information includes at least one subframe indicator indicating at least one subframe of the following CC, which includes data channel scheduled by the control information.

In accordance with another aspect of the present invention, there is provided a method of processing control information in a time division duplex (TDD) system, the method comprising the steps of receiving control information from a base station (BS) on one subframe of an ordering component carrier (CC), wherein the control information includes at least one subframe indicator indicating at least one subframe of a following CC, which includes data channel scheduled by the control information and TDD configuration of the ordering CC and the following CC including at least one uplink (UL) and downlink (DL) subframe each is set independently; and restoring data received from the following CC through use of the control information received from the ordering CC.

In accordance with another aspect of the present invention, there is provided a base station (BS) in a time division duplex (TDD) system, the BS comprising a controller to perform controlling so as to set TDD configuration including at least one uplink (UL) and downlink (DL) subframe, the TDD configuration corresponding to an ordering component carrier (CC) and a following CC each is set independently; and a transmitter to transmit control information to a user equipment (UE) on one subframe of the ordering CC, wherein the control information includes at least one subframe indicator indicating at least one subframe of the following CC, which includes data channel scheduled by the control information.

In accordance with another aspect of the present invention, there is provided a user equipment (UE) in a time division duplex (TDD) system, the UE comprising a receiver to receive control information from a base station (BS) on one subframe of an ordering component carrier (CC), wherein the control information includes at least one subframe indicator indicating at least one subframe of a following CC, which includes data channel scheduled by the control information and TDD configuration of the ordering CC and the following CC including at least one uplink (UL) and downlink (DL) subframe is set independently; and a controller to perform controlling so as to restore data received from the following CC through use of the control information received from the ordering CC.

In accordance with another aspect of the present invention, there is provided a method of processing control information in a time division duplex (TDD) system, the method comprising the steps of receiving data from a base station(BS) on one subframe of a following component carrier (CC) among an ordering CC and the following CC, wherein TDD configuration of the ordering CC and the following CC including at least one uplink (UL) and downlink (DL) subframe each is set independently; and restoring the data based on control information received through one previous subframe of the ordering CC when the control information indicating the one subframe of the following CC is not received through a subframe of the ordering CC corresponding to the same time.

In accordance with another aspect of the present invention, there is provided a user equipment (UE) in a time division duplex (TDD) system, the UE comprising a receiver to receive data from a base station on one subframe of a following carrier (CC) among an ordering CC and the following CC, wherein TDD configuration of the ordering CC and the following CC including at least one uplink (UL) and downlink (DL) subframe each is set independently; and a controller to perform controlling so as to restore the data based on control information received through one previous subframe of the ordering CC when the control information indicating the one subframe of the following CC is not received through a subframe of the ordering CC corresponding to the same time.

### BRIEF DESCRIPTION OF THE DRAWINGS

FIG. 1 is a diagram illustrating a radio communication system according to embodiments of the present invention.

FIG. 2 is a diagram illustrating an example of a structure of a radio frame of a time division duplex (TDD) system.

FIG. 3 is a diagram illustrating different TDD configurations of two component carriers (CCs).

FIG. 4 is a conceptual diagram illustrating cross carrier scheduling.

FIG. 5 is a conceptual diagram illustrating miss scheduling based on different TDD configurations of two CCs in a TDD system using a multi-CC.

FIG. 6 is a conceptual diagram illustrating a method of forming control information in a TDD system using a multi-CC according to an embodiment of the present invention.

FIG. 7 is a conceptual diagram illustrating a method of forming control information in a TDD system using a multi-CC according to another embodiment of the present invention.

FIG. 8 is a diagram illustrating a format of control information in a TDD system using a multi-CC according to another embodiment of the present invention.

FIGS. 9 through 11 are conceptual diagrams illustrating a method of forming control information in a TDD system using a multi-CC according to another embodiment of the present invention.

FIG. 12 is a diagram illustrating a format of control information in a TDD system using a multi-CC according to another embodiment of the present invention.

FIG. 13 is a flowchart illustrating a method for a base station (BS) to transmit and receive control information in a TDD system using a multi-CC according to another embodiment of the present invention.

FIG. 14 is a diagram illustrating a configuration of a BS according to another embodiment of the present invention.

FIG. 15 is a diagram illustrating a configuration of a user equipment (UE) according to another embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

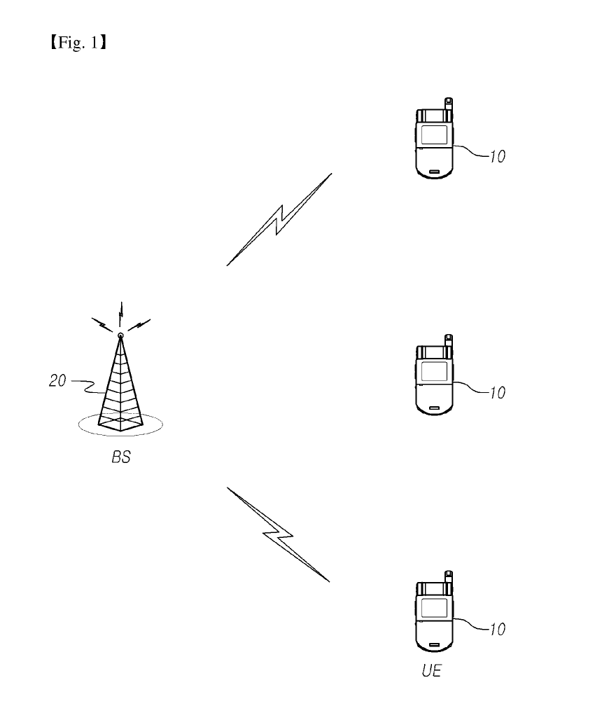

FIG. 1 illustrates a radio communication system according to embodiments of the present invention.

The radio communication system may be widely installed so as to provide various communication services, such as a voice service, packet data, and the like.

Referring to FIG. 1, the radio communication system may include a user equipment (UE) 10 and a base station (BS) or an e-Node B (eNB) 20. Throughout the specifications, the UE 10 may be an inclusive concept indicating a user terminal utilized in a radio communication, including a UE in WCDMA, LTE, HSPA, and the like, and a mobile station (MS), a user terminal (UT), a subscriber station (SS), a wireless device, and the like in GSM.

The BS 20 or a cell may refer to a station where communication with the UE 10 is performed, and may also be referred to as a Node-B, an evolved Node-B (eNB), a sector, a site, a base transceiver system (BTS), an access point, a relay node, and the like.

The BS 20 or the cell may be construed as an inclusive concept indicating a portion of an area covered by a base station controller (BSC) in CDMA, a Node B in WCDMA, an eNB or a sector (site) in LTE, and the like, and the concept may include various coverage areas, such as a megacell, macrocell, a microcell, a picocell, a femtocell, a communication range of a relay node, and the like.

In the specifications, the UE 10 and the BS 20 are used as two inclusive transceiving subjects to embody the technology and technical concepts described in the specifications, and may not be limited to a predetermined term or word. The UE 10 and the BS 20 are used as two inclusive transceiving subjects (for uplink (UL) or downlink (DL)) to embody the technology and technical concepts described in the specifications, and may not be limited to a predetermined term or word. Here, the UL may refer to a data transceiving scheme performed by the UE 10 with respect to the BS 20, and DL may refer to a data transceiving scheme performed by the BS 20 with respect to the UE 10.

A multiple access scheme applied to the radio communication system may not be limited. The radio communication system may utilize varied multiple access schemes, such as Code Division Multiple Access (CDMA), Time Division Multiple Access (TDMA), Frequency Division Multiple Access (FDMA), Orthogonal Frequency Division Multiple Access (OFDMA), OFDM-FDMA, OFDM-TDMA, OFDM-CDMA, and the like.

According to an embodiment of the present invention, a radio communication system may support a UL and/or DL hybrid automatic repeat request (HARQ). Also, layers of a radio interface protocol between a UE and a network may be distinguished as a first layer (L1), a second layer (L2), and a third layer (L3), based on three lower layers of a well-known open system interconnection (OSI) model in a communication system, and a physical layer of the L1 may provide an information transfer service through use of a physical channel.

UL transmission and DL transmission may be performed based on a time division duplex (TDD) scheme that performs transmission based on different times, or based on a frequency division duplex (FDD) scheme that performs transmission based on different frequencies. In the TDD scheme, the UL transmission and the DL transmission may be temporally distinguished based on a single component frequency.

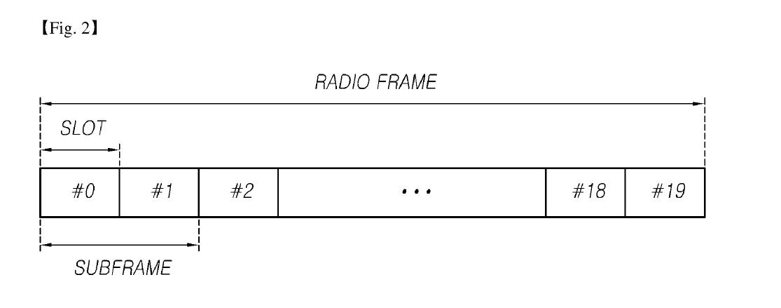

FIG. 2 illustrates an example of a structure of a radio frame of a time division duplex (TDD) system.

A base unit for data transmission may be a subframe, and UL scheduling or DL scheduling may be performed based on a subframe unit. A single slot may include a plurality of OFDM symbols in a time domain, and may include at least one subcarrier in a frequency domain. A single slot may include 7 or 6 OFDM symbols.

The structure of the radio frame is merely an example, and a number of subframes included in the radio frame, a number of slots included in a subframe, a number of OFDM symbols included in a slot, and a number of subcarriers included in a slot may variously vary.

Table 1 is an example of configuration information of a radio frame. The configuration information of the radio frame may indicate information associated with a rule that assigns a UL and a DL to all subframes included in a single radio frame.

According to the TDD scheme, when UL transmission and DL transmission are performed, a UL and DL TDD configuration may be as shown in Table 1. Each TDD configuration has a different UL-DL subframe transmission timing.

TABLE 1
UL-DL configurations

| | Downlink- | | | | | | | | | | |
|---|---|---|---|---|---|---|---|---|---|---|---|
| | to- | | | | | | | | | | |
| Uplink- | Uplink | | | | | | | | | | |
| downlink | Switch- | | | | | | | | | | |
| configura- | point | Subframe number | | | | | | | | | |
| tion | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In table 1, D corresponding to a subframe number denotes a DL subframe, and U denotes a UL subframe. S denotes a special subframe that is switched from a DL to a UP based on a DL-to-UP switch-point periodicity, and may operate as a DL. S may include a guard period (GP) to avoid interference between a UL and a DL, and may include a DL pilot time slot (DwPTS) and a UL pilot time slot (UpPTS). The DwPTS may be used for initial cell search, synchronization, or channel estimation. The UpPTS may be used for channel estimation in a BS, and for uplink transmission synchronization in a UE. A GP is a period for removing interference occurring in an UL due to a multiple route delay of a DL signal, between an UL and a DL.

According to the TDD scheme, a UL and a DL may be distinguished based on a subframe, and a UL subframe and a DL subframe may be separated by a special subframe. The special subframe may be a period existing between the UL subframe and the DL subframe and thus, may separate the UL and the DL. As shown in Table 1, at least one special subframe may exist in a radio frame.

A point in time when a DL is switched into a UL or a point in time when a UL is switched into a DL may be referred to as a switching point. A switch-point periodicity may refer to a period in which a pattern of switching between the UL subframe and the DL subframe is identically repeated, and may be 5 milliseconds (ms) or 10 ms. For example, in a case of configuration 0, switching is performed in an order of D→S→U→U→U from a 0th subframe to a 4th subframe, and switching is performed in an order of D→S→U→U→U from a 5th subframe to 9th subframe. A single subframe is 1 ms and thus, a switch-point periodicity may be 5 ms. That is, the switch-point periodicity may be less than a length (10 ms) of a single radio frame and the pattern of switching is repeated one time within the radio frame.

For all configurations, the 0th subframe, the 5th subframe, and the DwPTS may be used for DL transmission. A 1st subframe for all the configurations, and a 6th subframe for configurations 0, 1, 2, and 6 may include the DwPTS, the GP, and the UpPTS. A time length of each field may be different for each configuration. 8 remaining subframes excluding the 1st and 6th subframes may include two slots, respectively.

When the switch-point periodicity is 5 ms, the UpPTS and 2nd and 7th subframes may be reserved for UL transmission. When the switch-point periodicity is 10 ms, the UpPTS and the 2nd subframe may be reserved for UL transmission, and the DwPTS and the 7th and 9th subframes may be reserved for DL transmission.

The configuration information of Table 1 may be system information that both the BS 20 and the UE are aware of. The BS 20 may transmit only an index of the configuration information every time that the configuration information of the radio frame is changed so that the UE may be informed of a change in assignment of UL-DL in the radio frame. The configuration information may be one of the DL control information, and may be transmitted through a physical downlink control channel (PDCCH) that is a DL control channel, in the same manner as other scheduling information. Also, the configuration information may be control information transmitted to all UEs 10 in a cell in common through a broadcast channel. Also, the configuration information may be information included in system information.

A number of half-frames included in a radio frame, a number of subframes included in a half-frame, and a combination of DL subframes and UL subframes in the TDD system are merely examples.

An embodiment of the present invention may be applicable to resource allocation in an asynchronous radio communication scheme that is advanced through GSM, WCDMA, and HSPA, to be LTE and LTE-advanced, and may be applicable to resource allocation in a synchronous radio communication scheme that is advanced through CDMA and CDMA-2000, to be UMB. Embodiments of the present invention may not be limited to a specific radio communication scheme, and may be applicable to all technical fields to which a technical idea of the present invention is applicable.

In LTE, a standard may be developed by forming a UL and a DL based on a single CC or a pair of CCs. The UL and the DL may transmit control information through a control channel, such as a physical downlink control channel (PDCCH), a physical control format indicator channel (PCFICH), a physical hybrid ARQ indicator channel (PHICH), a physical uplink control channel (PUCCH), and the like, and may be configured as a data channel, such as a physical downlink shared channel (PDSCH), a physical uplink shared channel (PUSCH), and the like, so as to transmit data.

LTE uses a standard based on a single CC as a base and has discussed coupling of a few bands having a bandwidth of 20 megahertz (MHz) or less, whereas LTE-A has discussed a band of a CC having a bandwidth of 20 MHz or more. LTE-A has discussed a multi-carrier aggregation by taking backward compatibility into consideration based on the base standard of LTE. In a UL and a DL, up to five CCs are taken into consideration. Although a number of CCs used in the UL and the DL is considered to be five CCs, the example embodiments may not be limited thereto, and may increase or decrease the number of CCs based on an environment of a system.

In a CA environment, a plurality of CCs may be adjacent to one another, or may not be adjacent to one another since a frequency band is spaced apart from one another. Also, a DL CC and a UL CC exist independently and thus, a number of DL CCs and a number of UL CCs may be the same as or different from one another. The plurality of CCs may include at least one primary CC (PCC) and a least one secondary CC (SCC) that is different from the PCC. Through the PCC, a main measurement signal or control information may be transmitted and received. Also, the SCC may be assigned through the PCC. The PCC and the SCC may also be referred to as a primary cell (PCell) and a secondary cell (SCell), respectively.

DL and UL CC assignment may be set with respect to the UE 10 through a UE-specific dedicated signaling. A UE-specific DL active CC set may be a set of DL CCs that is set by an appointed signaling, for example, a MAC signaling (MAC message), that schedules the UE 10 to receive a data channel, for example, a PDSCH, in a DL. A UE-specific UL active CC set may be a set of UL CCs that is scheduled to enable the UE 10 to transmit a data channel, for example, a PUSCH, in a UL.

With respect to all active CCs in the CA environment, TDD configurations with respect to at least two CCs may be different from each other, as shown in Table 2. Through use of the different TDD configurations with respect to the at least two CCs, efficiency of a system may increase and a flexibility of resource allocation may increase.

TABLE 2
Different TDD configurations with respect to two CCs

| | | DL-to-UL | | | | | | | | | | |
|---|---|---|---|---|---|---|---|---|---|---|---|---|
| | UL-DL | Switch- | | | | | | | | | | |
| | config- | point | Subframe number | | | | | | | | | |
| CC | uration | periodicity | 0 | 1 | 2 | 3 | 4 | 5 | 6 | 7 | 8 | 9 |
| 1^{st} | TDD 0 | 5 ms | D | S | U | U | U | D | S | U | U | U |
| CC | | | | | | | | | | | | |
| 2^{nd} | TDD 2 | 5 ms | D | S | U | D | D | D | S | U | D | D |
| CC | | | | | | | | | | | | |

In table 2, when different TDD configurations are set with respect to two CCs, a TDD configuration set for one CC may have a value of 0, and a TDD configuration set for the other CC may have a value of 2.

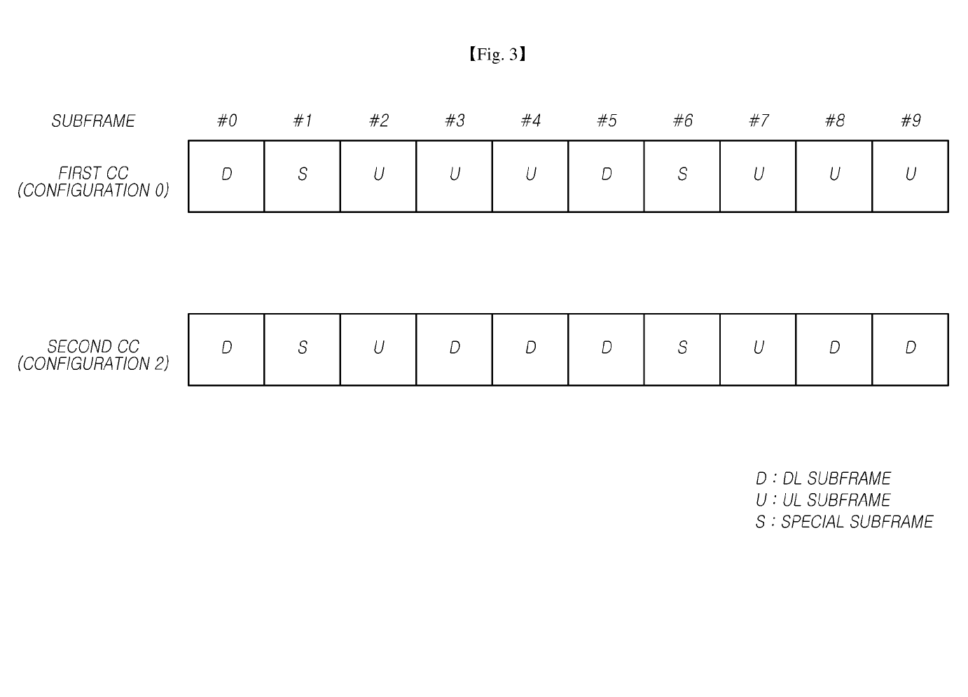

FIG. 3 illustrates different TDD configurations of two CCs of Table 2. As described in the foregoing, D denotes a DL subframe and U denotes a UL subframe. S denotes a special subframe that is switched from a DL to a UL based on a DL-to-UL switch-point periodicity, and may operate as a DL.

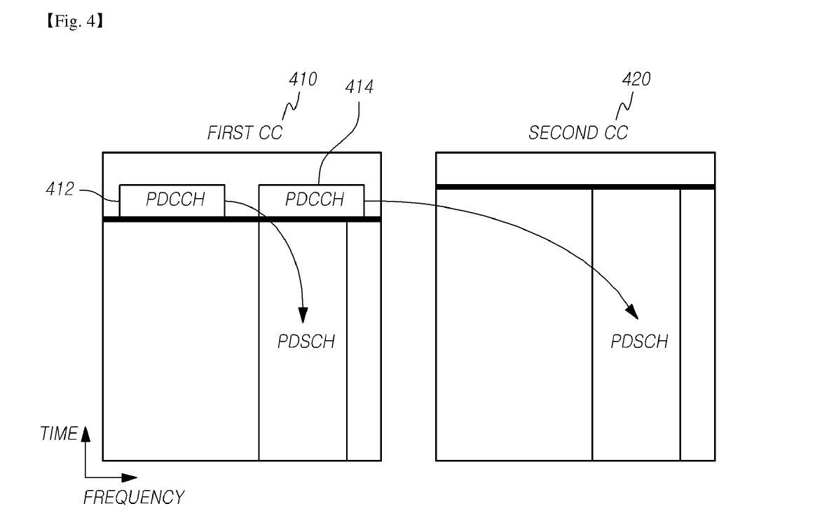

FIG. 4 illustrates cross carrier scheduling.

Referring to FIG. 4, in a general radio communication system using a plurality of CCs, a predetermined first CC 410 may transmit control information such as DL assignments, UL grants, and the like for a second CC 420, as well as for the first CC 410 itself including PDCCHs 412 and 414. As described in the foregoing, the PDCCHs included in a single CC may perform transmission of control information such as DL assignments, UL grants, and the like for two or more CCs, which is referred to as cross carrier scheduling. Hereinafter, the first CC 410 including the PDCCHs 412 and 144 may be referred to as an ordering CC. The second CC 420 that does not include PDCCHs and that transmits control information through use of one PDCCH 414 of the PDCCHs 412 and 414 included in a different CC may be referred to as a following CC.

In this example, a PDCCH may be located in a control region of a subframe of a CC indicated by a PCFICH as illustrated in FIG. 4, and may be located in a data region of the subframe. In this example, the control information corresponding to the PDCCH in the data to region of the subframe may be referred to as an extended PDCCH (E-PDCCH or X-PDCCH). Hereinafter, although the PDCCH may be illustratively described as a general PDCCH located in the control region, the PDCCH may be the E-PDCCH.

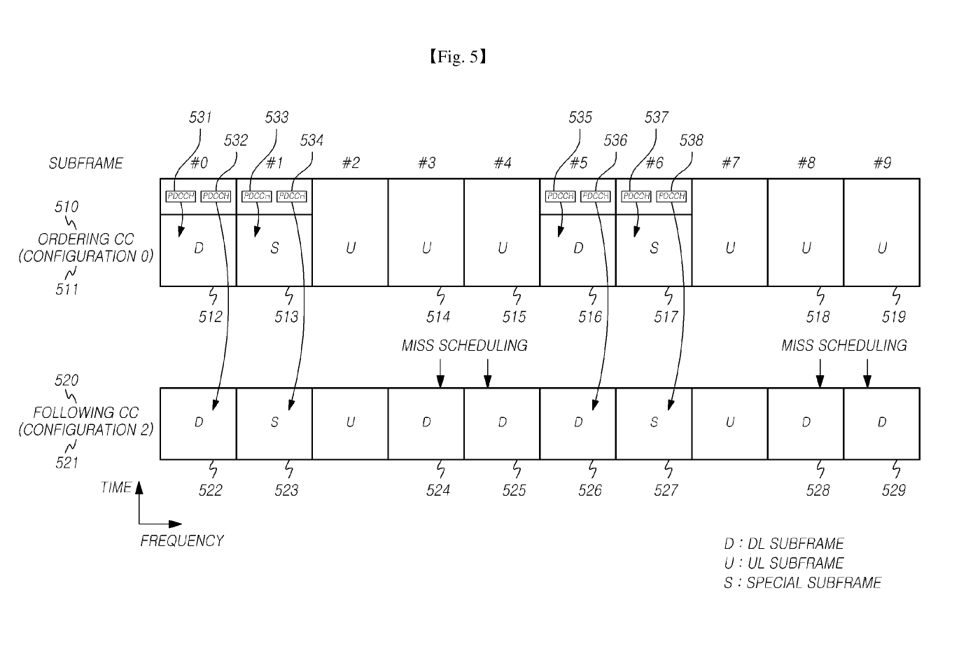

FIG. 5 illustrates miss scheduling based on different TDD configurations of two CCs in a TDD system using a multi-CC.

Referring to FIG. 5, when CCs, that is, an ordering CC 510 and a following CC 520, have different TDD configurations 511 and 521 as shown in Table 2, and PDCCHs of a predetermined CC perform cross carrier scheduling that transmits control information such as DL assignments, UL grants, and the like for the predetermined CC and another CC, predetermined subframes of the following CC 520 that do not include control information, for example a fourth subframe 524, a fifth subframe 525, a ninth subframe 528, and a tenth subframe 529, may become a miss scheduling state that does not include control information such as DL assignments and the like.

For example, one PDCCH 531 of the two PDCCHs 531 and 532 included in a first subframe 512 of the ordering CC 510 may indicate a PDSCH in the first subframe 512 of the ordering CC 510, and the other PDCCH 532 may indicate a PDSCH in a first subframe 522 of the following CC 520. Hereinafter, when a PDCCH indicates a subframe or a CC, it is construed that the PDCCH indicates a PDSCH in the subframe.

Two PDCCHs 533 and 534 included in a second subframe 513 of the ordering CC 510, two PDCCHs 535 and 536 included in a sixth subframe 516, and two PDCCHs 537 and 538 included in a seventh subframe 517 may perform cross carrier scheduling.

When a TDD configuration set for the ordering CC 510 has a value of 0 as shown in Table 2, UL transmission may be assigned to the ordering CC 510 during a transmission time for the fourth, fifth, ninth, and tenth subframes 514, 515, 518, and 519 of the ordering CC 510 so that UL transmission may be performed in a frequency band of the ordering CC 510.

Conversely, when the TDD configuration 521 set for the following CC 520 has a value of 2 as shown in Table 2, which is different from the TDD configuration 511 set for the ordering CC 510, DL transmission is assigned during a transmission time for the fourth, fifth, ninth, and tenth subframes 524, 525, 528, and 529 so that DL transmission is performed in a frequency band of the following CC 520. However, the fourth, fifth, ninth, and tenth subframes 524, 525, 528, and 529 of the following CC 520 may not include control information such as DL assignments and the like, and UL transmission is assigned during a transmission time for the subframes 514, 515, 518, and 519 of the ordering CC 510. Accordingly, DL subframes of the ordering CC 510 may not be transmitted and thus, cross carrier scheduling may not be performed. Therefore, control information for the fourth, fifth, ninth, and tenth subframes 524, 525, 528, and 529 of the following CC 520, such as DL assignments and the like, may not exist and thus, miss scheduling may occur that fails to restore the subframes 524, 525, 528, and 529 of the following CC 520.

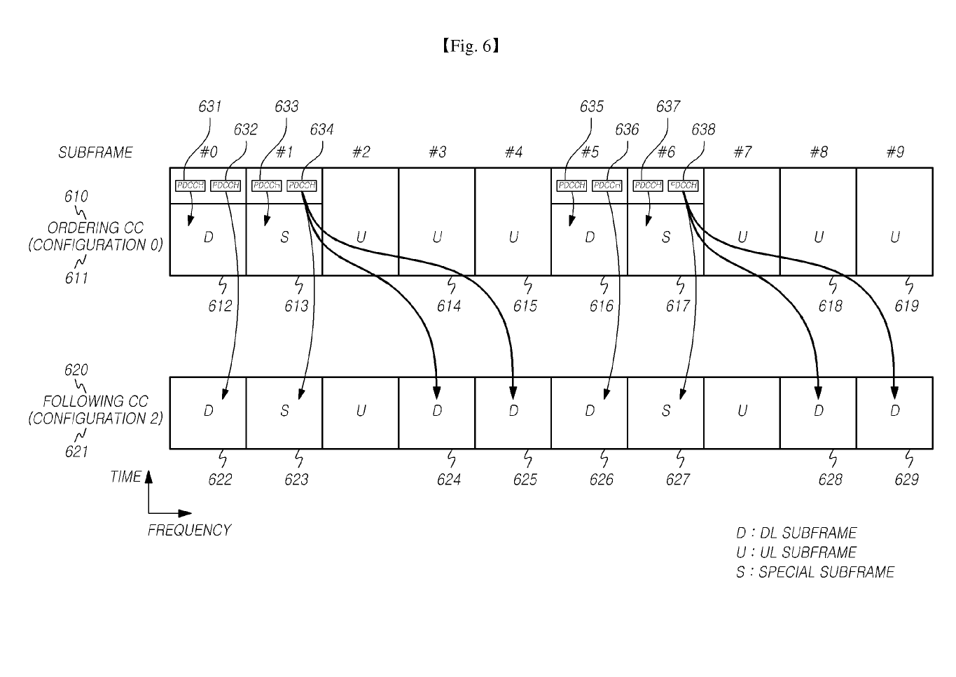

FIG. 6 illustrate a method of forming control information in a TDD system using a multi-CC according to an embodiment of the present invention

Referring to FIG. 6, in the TDD system using a multi-CC according to an embodiment of the present invention, a BS may configure radio frames by assigning a UL or a

DL to each subframe included in radio frames of active CCs. Each of the radio frames of the active CCs may be configured based on configuration information selected from the UL-DL configurations as shown in Table 1.

In particular, in the TDD system using a multi-CC, a TDD configuration 611 set for an ordering CC 610 and a TDD configuration 621 set for the following CC 620 may be different from one another. For example, the TDD configuration 611 set for the ordering CC 610 has a value of 0, and the TDD configuration 621 set for the following CC 620 has a value of 2, as shown in Table 2. The configuration information of the CCs 610 and 620 may be information included in system information, and may be transmitted to a UE(UEs) in a cell in common through a broadcasting channel.

According to cross carrier scheduling, one subframe in an ordering CC may include two or more PDCCHs, and one of the PDCCHs may transmit control information of the corresponding subframe of the ordering CC, such as DL assignments, UL grants, and the like, and another PDCCH may transmit control information of a corresponding subframe of a following CC, such as DL assignments, UL grants, and the like.

The control information carried through a PDCCH may include resource allocation information of a channel set within a time-frequency region, modulation and coding scheme (MCS) information, HARQ information, power control information, a channel status or channel quality request signal and the like.

For example, a first subframe 612 of the ordering CC 610 may include two PDCCHs 631 and 632, and one PDCCH 631 of the two PDCCHs 631 and 632 may transmit control information of the corresponding subframe 612 of the ordering CC 610 such as DL assignments and the like, and the other PDCCH 632 may transmit control information of a subframe 622 of the following CC 620 corresponding to the same time, such as DL assignments, and the like. In this example, a subframe including at least one PDCCH may be referred to as a self-subframe.

A PDCCH included in a self-subframe of an ordering CC may indicate or designate a subframe of a following CC corresponding to the same time based on a time axis (pure meaning of cross carrier scheduling) and may indicate or designate one or more subframes of a following CC corresponding to a subsequent time based on the time axis.

In other words, the PDCCH included in the self-subframe of the ordering CC may simultaneously indicate or designate a subframe of the following CC corresponding to the same time based on the time-axis and one or more subframes corresponding to a subsequent time based on the time axis. For example, one PDCCH 634 of the PDCCHs 633 and 634 included in a second subframe (self-subframe) 613 of the ordering CC 610 may simultaneously indicate a second subframe 623 of the following CC 620 and a fourth subframe 624 and a fifth subframe 625. Through use of control information transmitted through the PDCCH 634 included in the second subframe 613 of the ordering CC 610, such as DL assignments and the like, the UE 10 may restore data transmitted through a data channel(data channels) of the second subframe 623, the fourth subframe 624, and the fifth subframe 625 of the following CC 620.

In the same manner, one PDCCH 638 of the PDCCHs 637 and 638 included in a seventh subframe 617 of the ordering CC 610 may indicate a seventh subframe 627 of the following CC 620 along with a ninth subframe 628 and a tenth subframe 629. Through use of control information transmitted through the PDCCH 638 included in the seventh subframe 617 of the ordering CC 610, such as DL assignments and the like, the UE 10 may restore data transmitted through a data channel(data channels of the second subframe 627, the ninth subframe 628, and the tenth subframe 629 of the following CC 620. In this manner, a process in which a single PDCCH indicates two or more subframes may be referred to as PDCCH bundling.

When the PDCCH bundling as described in the foregoing is used, a drawback of miss scheduling may be overcome without adding a new field.

Referring again to FIG. 5, since control information, such as DL assignment and the like, for the fourth, fifth, ninth, and tenth subframes 542, 525, 528, and 529 of the following CC 520 do not exist, miss scheduling that fails to restore the subframes 542, 525, 528, and 529 may occur. When the subframes 542, 525, 528, and 529 are scheduled through the PDCCH bundling, the miss scheduling may not occur.

The TDD configuration information of the ordering CC 510 and the following CC 520 is known information in the TDD system. Therefore, a subframe where miss scheduling occurs may be recognized, and data of the corresponding subframe may be restored based on previously exchanged control information.

According to a case in which PDCCH bundling is applied in a UE, when the UE receives data included in the fourth subframe 542 of the following CC 520 and fails to receive control information indicating the fourth subframe 524 of the following CC 520 through the subframe 514 of the ordering CC 510 corresponding to the same time, the UE may restore the data based on previously received control information.

The previously received control information may be included in the second subframe 513 of the ordering CC 510, and although the control information is to indicate the second subframe 523 of the following CC 520 for cross carrier scheduling, the control information may also indicate miss scheduling subframes 542 and 525 of a subsequent time based on the PDCCH bundling.

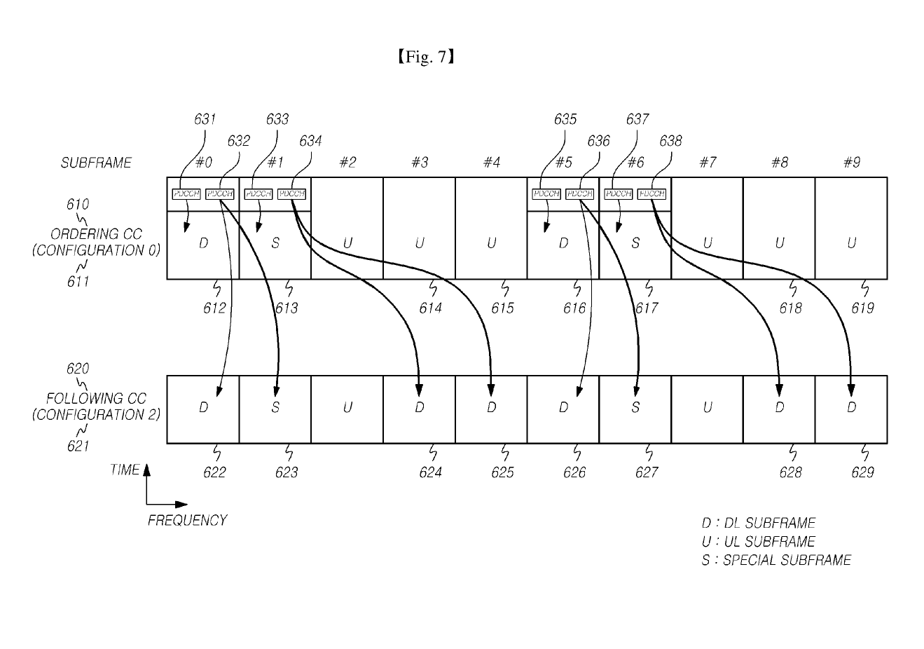

FIG. 7 illustrates a method of forming control information in a TDD system using a multi-CC according to another embodiment of the present invention.

Although a PDCCH included in a predetermined subframe of an ordering CC simultaneously indicates a subframe of a following CC corresponding to the same time as a self-subframe of the ordering CC, and at least one subframe of the following CC corresponding to a subsequent time based on a time axis, the PDCCH may not indicate the second subframe 623 of the following CC 620 corresponding to the self-subframe of the ordering CC 610, for example, the second subframe 613, and may indicate at least one subframe, for example subframes 624 and 625, of the following CC 620 corresponding to a subsequent time based on the time axis. In a broad sense, this process may also be referred to as PDCCH bundling.

In this example, one PDCCH 632 of the PDCCHs 631 and 632 included in the first subframe 612 of the ordering CC 610 may indicate a second subframe 623 of the following CC 620. Accordingly, the one PDCCH 632 of the PDCCHs 631 and 632 included in the first subframe 612 of the ordering CC 610 may perform PDCCH bundling that simultaneously indicates the first and second subframes 622 and 623 of the following CC 620 corresponding to the same time.

When the PDCCH bundling is performed, a DCI format may need to include an additional field indicating which subframe of a CC designated by a carrier indication field (CIF) is indicated or designated, in addition to the CIF indicating a CC designated by the PDCCH.

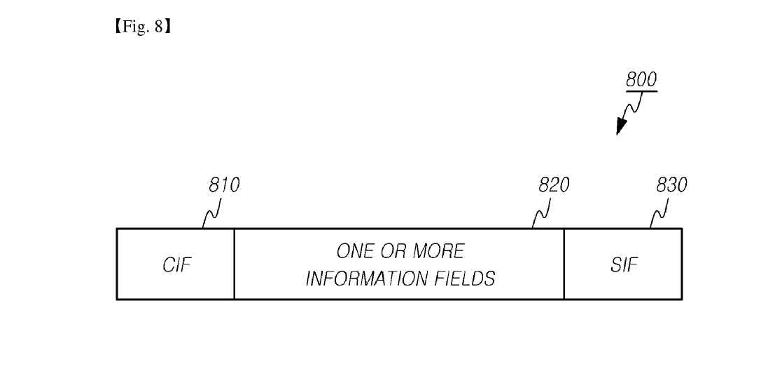

FIG. 8 illustrates a format of control information in a TDD system using a multi-CC according to another embodiment of the present invention.

Referring to FIG. 8, in a TDD system using a multi-CC according to another embodiment of the present invention, a format 800 of control information transmitted by a

PDCCH included in a subframe of an ordering CC may include a CIF 810, one or more information fields 820, and a subframe index (indicator) field (SIF) 830.

The CIF 810 may include a carrier indicator of 0 bits or a predetermined number of bits, for example, 3 bits.

The one or more information fields 820 may include at least one or two of resource block assignment information, MCS (5 bits), HARQ process number (3 bits (FDD) and 4 bits (TDD)), and power controlling information for a UL control channel (a TPC command for a PUCCH (2 bits)). When two or more information fields 820 exist, additional fields may be formed and may carry corresponding control information.

The SIF 830 may be a subframe indicator or designator, and may indicate at least one subframe of a following CC indicated by a PDCCH during PDCCH bundling. The SIF 830 may have 0 bits or a predetermined number of bits, for example, 3 bits or 4 bits.

The SIF 830 may use 0 bits when indicating only a subframe of the following CC corresponding to the same time, based on a time axis, as the ordering CC that carriers the corresponding PDCCH. When a subframe n of the following CC corresponding to the same time, based on the time axis, as a subframe n of the ordering CC that carriers the corresponding PDCCH, and at least one subsequent subframe are indicated, the SIF 830 may use four bits so as to indicate the subframe n and up to three subsequent subframes n+1, n+2, and n+3 through use of a bitmap format. When a value of a TDD configuration of the ordering CC is 0 and a value of a TDD configuration of the following CC is 6 based on configuration information, eighth through ninth subframes of the ordering CC may correspond to UL transmission and thus, the SIF 830 may need four bits to indicate up to four subframes through use of a bitmap format.

For example, when a value of the SIF 830 is 1100, it may indicate that the PDCCH is used for DL assignments for the subframe n and the subsequent subframe n+1. As another example, when a value of the SIF 830 is 1011, it may indicate that the PDCCH is used for DL assignments for the subframe n and the subframes n+2 and n+3.

TABLE 3

| SIF value (4 bits) | Information |
|---|---|
| 1*** | The corresponding PDCCH |
| | indicates the subframe n of |
| | the following CC |
| *1** | The corresponding PDCCH |
| | indicates the subframe n + 1 of |
| | the following CC |
| **1* | The corresponding PDCCH |
| | indicates the subframe n + 2 of |
| | the following CC |
| ***1 | The corresponding PDCCH |
| | indicates the subframe n + 3 of |
| | the following CC |

When at least one subframe corresponding to a subsequent time of the following CC corresponding to the same time as the subframe n of the ordering CC that carries the corresponding PDCCH is indicated, the SIF 830 may use 3 bits to indicate up to three subsequent subframes n+1, n+2, n+3 of the following CC through use of a bitmap format. As described in the foregoing, when the value of the SIF 830 is 100, it may indicate that the PDCCH is used for

DL assignments for the subframe n+1 corresponding to a subsequent time of the subframe n. As another example, when the value of the SIF 830 is 011, it may indicate that the PDCCH is used for DL assignments for the subframe n+2 and n+3 corresponding to a subsequent time of the subframe n. In this example, using the PDCCH for DL assignment for the subframe n is default and thus, it may not be expressed in the SIF 830.

TABLE 4

| SIF value (3 bits) | Information |
|---|---|
| 1** | The corresponding PDCCH |
| | indicates the subframe n + 1 of |
| | the following CC |
| *1* | The corresponding PDCCH |
| | indicates the subframe n + 2 of |
| | the following CC |
| **1 | The corresponding PDCCH |
| | indicates the subframe n + 3 of |
| | the following CC |

The SIF 830 included in the control information transmitted by the PDCCH may reuse a field that is already defined to be used for transferring different information.

Also, in the foregoing descriptions, the CIF 810 and the SIF 830 are described to be separate fields, but a subframe indicator included in the SIF may be included in the CIF 810 for transmission. For example, when two CCs are used in a CA environment, the CIF field formed of 3 bits may have a case that indicates a PCC, and have remaining 7 cases that indicate a CC (SCC) different from the PCC and simultaneously express a subframe indicator. According is to the TDD configuration in Table 1, a number of cases that indicate an SCC and express a subframe indicated from among subframes of the SCC through use of the subframe indicator may be 7, as shown in Table 5, and may be expressed by the remaining 7 cases of the CIF. Therefore, both a carrier indicator and subframe indicator information may be expressed by the CIF field.

TABLE 5

| | Case | | | | | | | | | | | | | | | | | | | | |
|---|---|---|---|---|---|---|---|---|---|---|---|---|---|---|---|---|---|---|---|---|---|
| | 1 | 2 | | 3 | | | 4 | | | 5 | | | | 6 | | | | 7 | | | |
| Subframe | n | n | n + 1 | n | n + 1 | n + 2 | n | n + 1 | n + 2 | n | n + 1 | n + 2 | n + 3 | n | n + 1 | n + 2 | n + 3 | n | n + 1 | n + 2 | n + 3 |
| PCC | D | D | U | D | U | U | D | U | U | D | U | U | U | D | U | U | U | D | U | U | U |
| SCC | D | D | D | D | D | D | D | U | D | D | U | U | D | D | U | D | D | D | D | D | D |

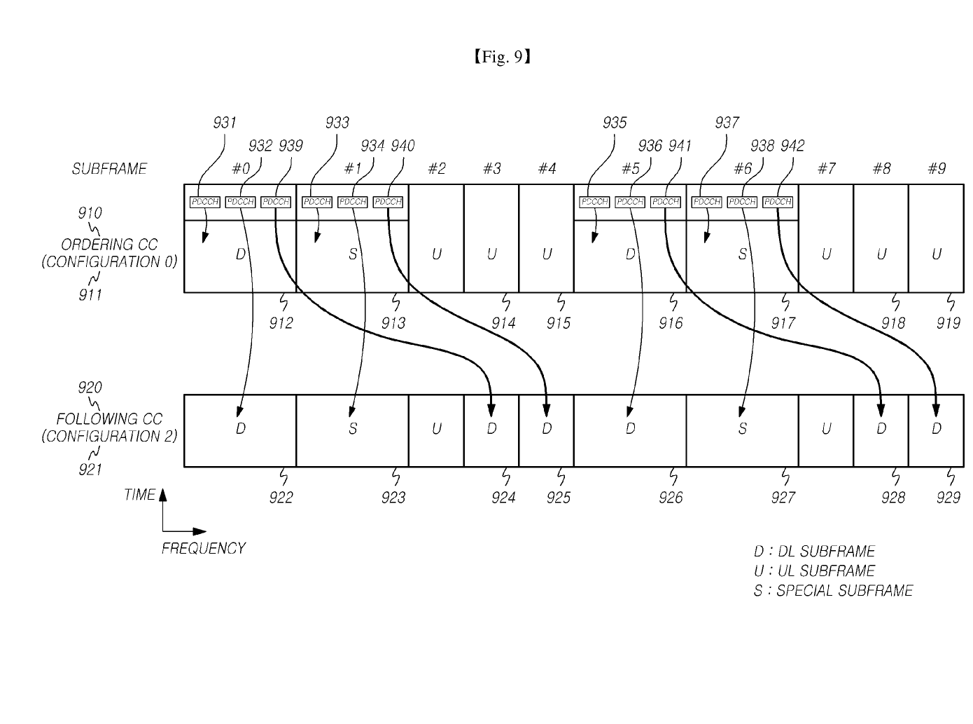

FIG. 9 illustrates a method of forming control information in a TDD system using a multi-CC according to another embodiment of the present invention.

Referring to FIG. 9, according to cross carrier scheduling, at least one subframe of an ordering CC may include a first PDCCH that includes control information such as DL assignments for a corresponding subframe of the ordering CC and the like, a second PDCCH to including control information such as DL assignments for a corresponding subframe of a following CC, and a third PDCCH including control information such as DL assignments for at least one subframe of the following CC corresponding to a subsequent time based on a time axis and the like.

For example, a first subframe 912 of an ordering CC 910 may include a first PDCCH 931 indicating a self-subframe, a second PDCCH 932 indicating a first subframe 922 of a following CC 920, and a third PDCCH 939 indicating a fourth subframe 924 of the following CC 920 corresponding to a subsequent time based on the time axis.

In the same manner, a second subframe 913 of the ordering CC 910 may include a first PDCCH 933 indicating the subframe itself, a second PDCCH 934 indicating a second subframe 923 of the following CC 920, and a third PDCCH 940 indicating a fifth subframe 925 of the following CC 920 based on the time axis.

In this example, a process in which the first subframe 912 of the ordering CC 910 includes the third PDCCH 939 indicating the fourth subframe 924 of the following CC 920 and the second subframe 913 includes the third PDCCH 940 indicating the fifth subframe 925 of the following CC 920 may be referred to as PDCCH timing multiplexing.

In the same manner, a sixth subframe 916 of the ordering CC 910 may include a first PDCCH 935 indicating the subframe itself, a second PDCCH 936 indicating a sixth subframe 926 of the following CC 920, and a third PDCCH 941 indicating a ninth subframe 928 of the following CC 920 based on the time axis. In the same manner, a seventh subframe 917 of the ordering CC 910 may include a first PDCCH 937 indicating the subframe itself, a second PDCCH 938 indicating a seventh subframe 927 of the following CC 920, and a third PDCCH 942 indicating a tenth subframe 929 of the following CC 920 based on the time axis.

In this example, when PDCCH timing multiplexing is performed, one of the subframes of an ordering CC may include two or more PDCCHs that respectively indicate two or more subframes of a following CC. A single PDCCH may indicate only a predetermined subframe of a single following CC, and a single subframe of the ordering CC may include two or more PDCCHs respectively indicating predetermined subframes of the following CC.

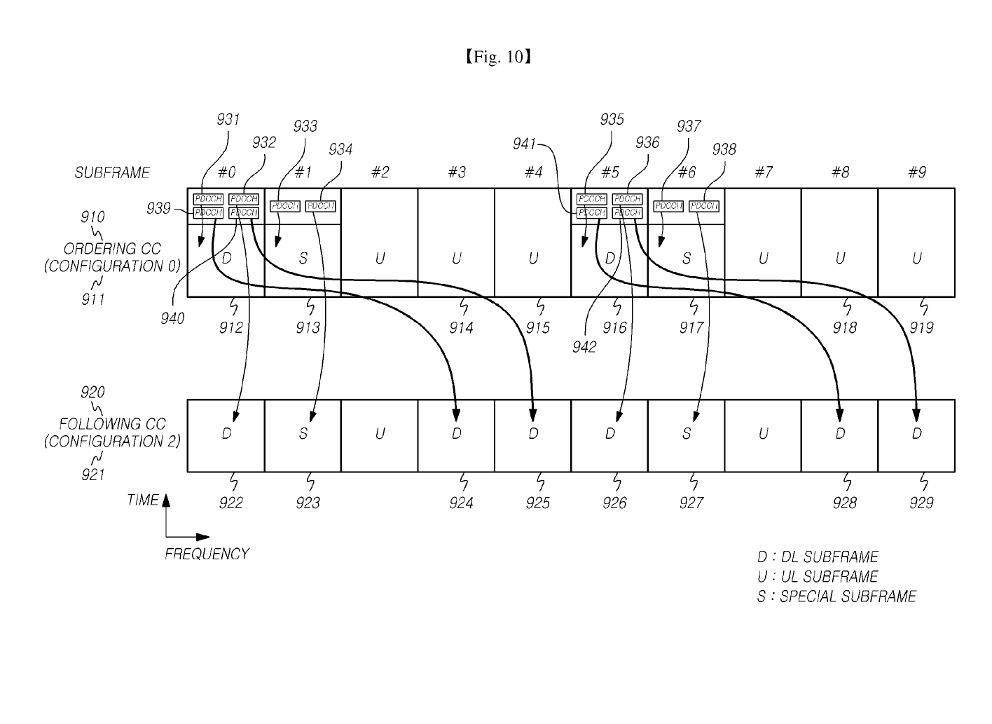

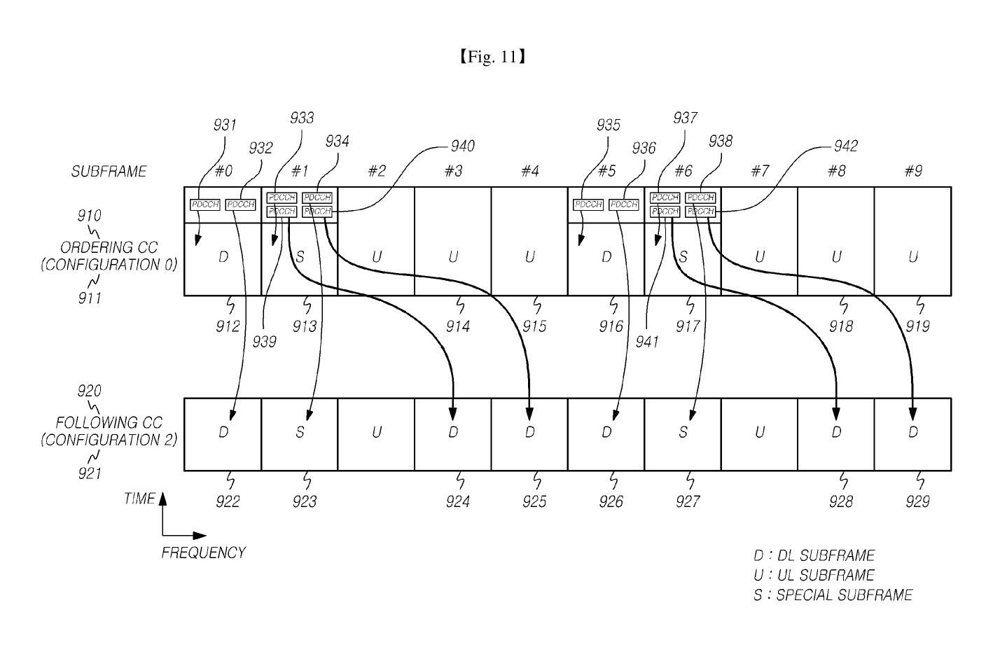

The first subframe 912 of the ordering CC 910 may include the PDCCHs 939 and 940 that respectively indicate the fourth and fifth subframes 924 and 925 of the following CC 920 as illustrated in FIG. 10, or the second subframe 913 of the ordering CC 910 may include the PDCCHs 939 and 940 that respectively indicate fourth and fifth subframes of the following CC 920 as illustrated in FIG. 11.

The UE 10 that receives the PDCCH timing multiplexed PDCCHs from a single subframe may restore data of subframes designated by each PDCCH.

When the PDCCH timing multiplexing is performed, a DCI format may need to include an additional field indicating which subframe of a CC designated by a CIF is indicated by each PDCCH, in addition to the CIF indicating the CC indicated by each PDCCH.

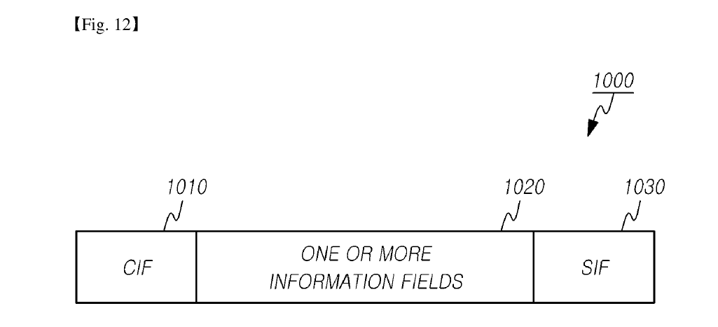

FIG. 12 illustrates a format of control information in a TDD system using a multi-CC according to another embodiment of the present invention.

Referring to FIG. 10, in the TDD system using a multi-CC according to another embodiment of the present invention, a format 1000 of the control information may include a CIF 1010, one or more information fields 1020, and an SIF 1030.

The CIF 610 may include a carrier indicator of 0 bits or a predetermined number of bits, for example, 3 bits.

The one or more information fields 1020 may include at least one or two of is resource block assignment information, MCS (5 bits), HARQ process number (3 bits (FDD) and 4 bits (TDD)), and power controlling information for a UL control channel (a TPC command for a PUCCH (2 bits)). When two or more information fields 1020 exist, additional fields may be configured to carry corresponding control information.

The SIF 1030 may indicate which subframe of a CC designated by a CIF is indicated by each PDCCH in a DCI format when the PDCCH timing multiplexing is performed. The SIF 1030 may have 0 bits or a predetermined number of bits, for example, 2 bits.

The SIF 1030 may use 0 bits when indicating only a subframe of a following CC corresponding to the same time, based on a time axis, as a subframe of an ordering CC that carries a corresponding PDCCH. When indicating one of a subframe n of the following CC corresponding to the same time, based on the time axis, as a subframe n of the ordering CC that carries the corresponding PDCCH and at least one subframe of a subsequent time during the PDCCH timing multiplexing, the SIF 1030 may use 2 bits to designate one of the subframe n, and subframes n+1, n+2, and n+3 of the following CC.

For example, when a value of the SIF 1030 is 00, it may indicate that the corresponding PDCCH designates the subframe n of the following CC from among the subframe n of the following CC designated by a CIF and subsequent subframes n+1, n+2, and n+3. In the same manner, when the value of the SIF 1030 is “01” “10”, and “11”, it may indicate that the corresponding PDCCH designates subframes n+1, n+2, and n+3 of the following CC, respectively, from among the subframe n of the following CC designated by the CIF and the subsequent subframes n+1, n+2, and n+3.

TABLE 6

| SIF value | Information |
|---|---|
| 00 | The corresponding PDCCH |
| | designates the subframe n of the |
| | following CC |
| 01 | The corresponding PDCCH |
| | designates the subframe n + 1 of |
| | the following CC |
| 10 | The corresponding PDCCH |
| | designates the subframe n + 2 of |
| | the following CC |
| 11 | The corresponding PDCCH |
| | designates the subframe n + 3 of |
| | the following CC |

When indicating only the subframe n of the following CC corresponding to the same time, based on the time axis, as the subframe n of the ordering CC that carries the corresponding PDCCH during the PDCCH timing multiplexing, the SIF 1030 may use 0 bits. When indicating one of the at least one subframe corresponding to a subsequent time, the SIF 1030 may use 2 bits to designate one of the subframes n+1, n+2, and n+3 subsequent to the subframe n of the following CC.

For example, when the value of the SIF 1030 is 00, it may indicate that the corresponding PDCCH designates the subframe n+1 of the following CC from among the subsequent subframes n+1, n+2, and n+3 of the subframe n of the following CC. In the same manner, when the value of the SIF 1030 is “01” and “10”, it may indicate that the corresponding PDCCH may designate subframes n+2 and n+3, respectively, from among the subframes n+1, n+2, and n+3 subsequent to the subframe n of the following CC.

TABLE 7

| SIF value | Information |
|---|---|
| 00 | The PDCCH designates the subframe |
| | n + 1 of the following CC |
| 01 | The PDCCH designates the subframe |
| | n + 2 of the following CC |
| 10 | The PDCCH designates the subframe |
| | n + 3 of the following CC |
| 11 | reserved |

The SIF 1030 included in control information transmitted by the PDCCH may reuse a field that is already defined to be used for transferring different information.

Also, in the foregoing descriptions, the CIF 1010 and the SIF 1030 are described to be separate fields, but a subframe indicator included in the SIF may be included in the CIF 1010 for transmission. For example, when two CCs are used in a CA environment, the CIF field formed of 3 bits may have a case that indicates a PCC, and have remaining 7 cases that indicate a CC (SCC) different from the PCC and simultaneously express a subframe indicator. A number of cases that indicate an SCC and express a subframe indicated from among subframes of the SCC through use of the subframe indicator may be 4, and may be expressed by the remaining 7 cases of the CIF. Therefore, both a carrier indicator and subframe indicator information may be expressed by the CIF field.

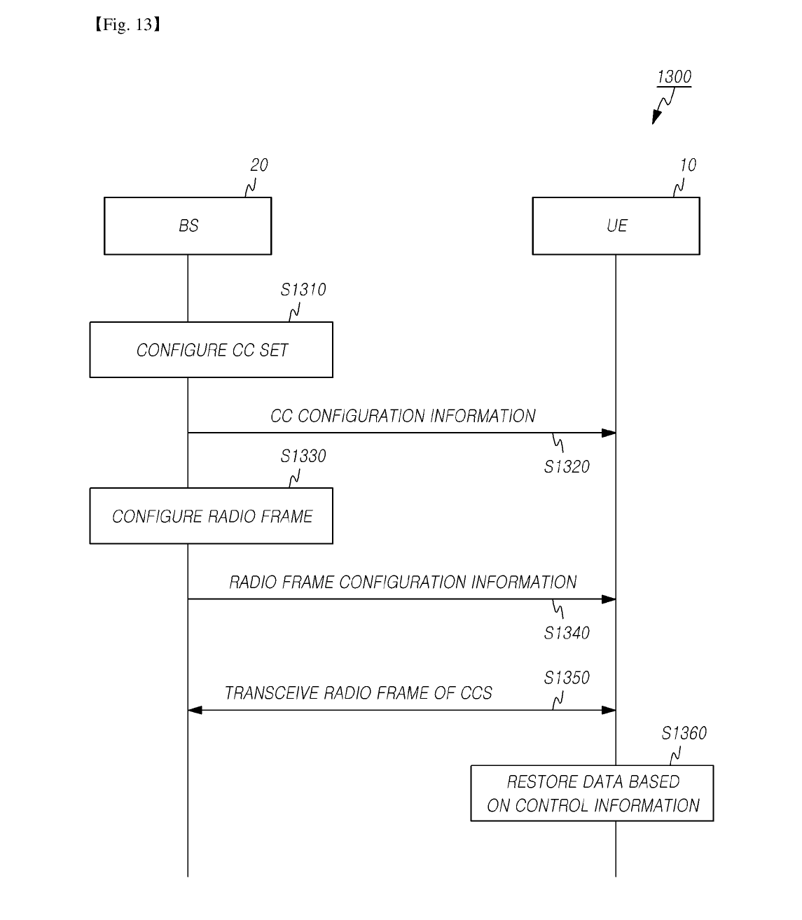

FIG. 13 illustrates a method for a BS to transmit and receive control information in a TDD system using a multi-CC according to another embodiment of the present invention.

Referring to FIGS. 1 and 13, the BS 20 may set one or more DL and UL CCs with respect to a predetermined UE 10 (step S1310). In particular, the BS 20 may set a UE-specific DL active set of DL CCs that schedules the predetermined UE 10 to receive a data channel, for example, a PDSCH, in a DL. Also, the BS 20 may set a UE-specific UL active CC set that schedules the predetermined UE 10 to transmit a data channel, for example, a PUSCH, in a UL.

The BS 20 may transmit, to the UE 10, CC configuration information including the UE-specific DL active set of DL CCs and the UE-specific UL active CC set, through a UE-specific dedicated signaling (step S1320). The UE-specific dedicated signaling may be MAC signaling or MAC message transmission, but may not be limited thereto.

In step S1320, the UE 10 may receive, from the BS 20, the CC configuration information including the UE-specific DL active set of DL CCs and the UE-specific UL active CC set, through the UE-specific dedicated signaling. The UE 10 may store the received CC configuration information in a storage device.

The UE 10 and the BS 20 may perform transmission and reception of control information through the one or more DL and UL CCs, based on the CC configuration information.

When two or more CCs are designated with respect to the predetermined UE 10 in step S1311, the BS 20 may set a TDD scheme-based radio frame of two or more CCs (step S1330).

The radio frame may include at least one DL subframe and at least one UL subframe. The DL subframe may be a subframe reserved for DL transmission and the UL subframe may be a subframe reserved for UL transmission.

Setting TDD schemes of two or more CCs or setting a radio frame may correspond to setting of whether each of a plurality of subframes included in the radio frame is set for UL transmission or DL transmission. Information associated with a DL-UL assignment pattern in a single radio frame may be referred to as configuration information or information on a configuration.

A range of the configuration information may refer to a configuration associated with a UL/DL subframe as shown in Table 1. As described in the foregoing, the configuration information may be different for each CC.

Subsequently, the BS 20 may transmit the configuration information of the radio frame to the UE 10 (step S1340). The configuration information of the radio frame may be a single piece of configuration information that is selected from Table 1. The configuration information may be transmitted through a broadcast channel. Also, the configuration information may be transmitted through a PDCCH which is a DL control channel. Also, the configuration information may be transmitted as a portion of system information.

In step S1340, the UE 10 may receive the configuration information of the radio frame that is transmitted from the BS 20 based on the described transmission scheme.

The BS 20 and the UE 10 may perform transmission and reception of control information and data through use of the TDD scheme-based radio frame set in step S1330 of two or more UL and DL CCs set in step S1310 (step S1350).

In this example, during cross carrier scheduling, a predetermined subframe of an ordering CC may include a PDCCH indicating a subframe of a following CC corresponding to the same time based on a time axis. For example, when the TDD schemes of the two or more CCs are different from each other, one PDCCH included in a predetermined subframe of the ordering CC may indicate two or more subframes of the following CC through the PDCCH bundling as described in FIGS. 6 and 7, or a predetermined subframe of the ordering CC may include two or more PDCCHs that respectively indicate subframes of the following CC through the PDCCH timing multiplexing as described in FIGS. 9 through 11.

In this example, the subframes of the following CC may correspond to a subframe of the following CC corresponding to the same time, based on the time axis, as the subframe of the ordering CC and a subframe of the following CC corresponding to a subsequent time based on the time axis, or may correspond to just the subframes of the following CC corresponding to the subsequent time of the subframe of the ordering CC based on the time axis.

A format of control information of a single PDCCH that is included in a predetermined subframe of the ordering CC, and that simultaneously indicates two or more subframes of the following CC during the PDCCH bundling, has been described with reference to FIG. 8, and Tables 3 and 4. Also, formats of two or more additional PDCCHs that are included in a predetermined subframe of the ordering CC and that indicate subframes of the following CC, respectively, during the PDCCH time multiplexing, has been described with reference to FIG. 12 and Tables 5 and 6.

The UE 10 may restore data from the control information and data received through the radio frames of the two or more DL CCs in step S1350, through use of the control information (step S1360).

During the PDCCH bundling, the UE 10 may determine for which subframes of which CC the control information, such as DL assignments and the like, included in one or more information fields is to be used, based on a CIF value and an SIF value of control information of a single PDCCH included in the predetermined subframe of the ordering CC that simultaneously indicates two or more subframes of the following CC. That is, the UE 10 may determine, based on the CIF value and the SIF value, a transmission scheme and subframes of a CC to which data to be received by the UE 10 is transmitted, and may receive and restore DL data through use of radio resources of the corresponding subframes of the corresponding CC.

In the same manner, during the PDCCH timing multiplexing, the UE 10 may determine for which subframes of which CC the control information, such as DL assignment and the like, included in an information field is to be used, based on CIF values and SIF values of control information of the two or more PDCCHs included in the predetermined subframe of the ordering CC that respectively indicate two or more subframes of the following CC.

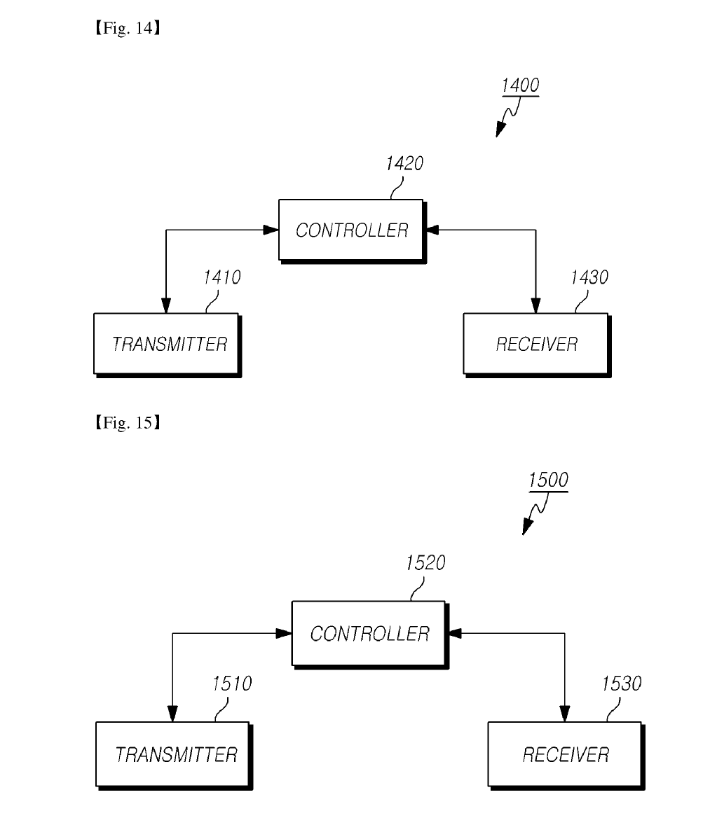

FIG. 14 illustrates a configuration of a BS according to another embodiment of the present invention.

Referring to FIG. 14, a BS 1400 may be configured to include a transmitter 1410 and a receiver 1430 for transmission and reception of a radio signal with a UE, and a controller 1420 to control the transmitter 1410 and the receiver 1430.

The transmitter 1410 may transmit CC configuration information of a predetermined UE to the predetermined UE. Also, the transmitter 1410 may transmit TDD configuration information or radio frame configuration information of the predetermined UE to the predetermined UE.

In other words, the transmitter 1410 may transmit control information to the UE through a control channel that is included in at least one subframe of one of the at least two CCs having different TDD configurations, and that indicates at least two subframes of another CC of the at least two CCs, during PDCCH bundling. The transmitter 1410 may transmit control information to the UE through at least two channels that are included in at least one subframe of one of the at least two CCs having different TDD configurations, and that respectively indicate at least two subframes of another CC of the at least two CCs, during PDCCH time multiplexing .

The receiver 1430 may receive control information and data included in a UL radio frame from the UE, based on the CC configuration information of the predetermined UE and the TDD configuration information or the radio frame configuration information.

The controller 1420 may control the transmitter 1410 and the receiver 1430. Also, the controller 1420 may set CC configuration information including a UE-specific DL active set of DL CCs and a UE-specific UL active CC set. Also, the controller 1420 may determine a configuration of TDD schemes of two or more CCs or configuration of a radio frame.

When the TDD schemes of the two or more CCs are different from one another, the controller 1420 may control one PDCCH included in a predetermined subframe of an ordering CC to indicate two or more subframes of a following CC through the PDCCH bundling with reference to FIGS. 6 and 7, or may control a predetermined subframe of an ordering CC to include two or more additional PDCCHs that respectively indicate subframes of a following CC with reference to FIGS. 9 through 11.

In other words, the controller 1420 may perform controlling so as to configure a radio frame to enable TDD configurations of at least two CCs including at least one UL and DL subframe to be different from each other during the PDCCH bundling. The controller 1420 may perform controlling so as to configure a radio frame to enable TDD configurations of at least two CCs including at least one UL and DL subframe to be different from each other during the PDCCH timing multiplexing.

FIG. 15 illustrates a configuration of a UE according to another embodiment of the present invention.

Referring to FIG. 15, a UE 1500 may be configured to include a transmitter 1510 and a receiver 1530 for transmission and reception of a radio signal with a BS, and a controller 1520 to control the transmitter 1510 and the receiver 1530.

The transmitter 1510 may transmit data and control information through a UL radio frame, based on the CC configuration information of the UE 1500 received from the BS and TDD configuration information or radio frame configuration information.

The receiver 1530 may receive, from the BS, the CC configuration information of the UE 1500, and TDD configuration information or the radio frame configuration information.

The receiver 1530 may receive control information from the BS, through at least two control channels that are included in at least one subframe of one of the at least two CCs having different TDD configurations and including at least one UL and DL subframe, and that respectively indicate at least two subframes of another CC of the at least two CCs, during PDCCH bundling. The receiver 1530 may receive control information from the BS, through at least two control channels that are included in at least one subframe of one of the at least two CCs having different TDD configurations and including at least one UL and DL subframe, and that respectively indicate at least two subframes of another CC of the at least two CCs, during PDCCH timing multiplexing.

The controller 1520 may control the transmitter 1510 and the receiver 1530. Also, the controller 1520 may restore data through use of control information received through radio frames of two or more DL CCs. In particular, the controller 1520 may determine a transmission scheme and subframes of a CC to which data to be received by the UE is transmitted, based on a CIF value and an SIF value of the controller, and may perform controlling so as to receive and restore DL data through use of radio resources of the corresponding subframes of the corresponding CC.

In other words, the controller 1520 may perform controlling so as to restore data received from at least two CCs having different TDD configurations, through use of the control information received through the control channel.

Although the embodiments of the present invention describes that the PDCCH bundling and the PDCCH timing multiplexing are separately performed, the PDCCH bundling and the PDCCH timing multiplexing may be simultaneously performed with respect to a PDCCH of one or more subframes of a single ordering CC. For example, a PDCCH of one subframe of the ordering CC may perform the PDCCH bundling, and a PDCCH of another subframe may perform the PDCCH timing multiplexing. One PDCCH of the PDCCHs included in one subframe of the ordering CC may perform the PDCCH bundling and another PDCCH may perform the PDCCH timing multiplexing.

According to the embodiments of the present invention, when different TDD configurations are set with respect to at least two CCs to increase an efficiency of a system and to improve a flexibility of resource allocation, the PDCCH bundling or the PDCCH timing multiplexing may be used and thus, a miss or an error in scheduling of the at least two CCs may be prevented.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of transmitting control information in a time division duplex (TDD) system, the method comprising the steps of:
setting TDD configuration including at least one uplink (UL) and downlink (DL) subframe, the TDD configuration corresponding to an ordering component carrier (CC) and a following CC each is set independently; and
transmitting control information to a user equipment (UE) on one subframe of the ordering CC, wherein the control information includes at least one subframe indicator indicating at least one subframe of the following CC, which includes data channel scheduled by the control information.

2. The method as claimed in claim 1, wherein the subframe indicator indicates assignment of the at least one subframe of the following CC through use of bit value.

3. The method as claimed in claim 1, wherein the subframe indicator includes codeword related to index of a predetermined table, and the codeword indicates assignment of the at least one subframe of the following CC based on the subframe of the ordering CC that carries the control information.

4. The method as claimed in claim 1, wherein the subframe indicator includes predetermined number bits of a bitmap format, and each of the predetermined number bits indicates each assignment of the at least one subframe of the following CC.

5. The method as claimed in claim 1, wherein each of the at least subframe indicator is transmitted through a physical downlink control channel (PDCCH) and indicates a subframe of the following CC.

6. A method of processing control information in a time division duplex (TDD) system, the method comprising the steps of:
receiving control information from a base station (BS) on one subframe of an ordering component carrier (CC), wherein the control information includes at least one subframe indicator indicating at least one subframe of a following CC, which includes data channel scheduled by the control information and TDD configuration of the ordering CC and the following CC including at least one uplink (UL) and downlink (DL) subframe each is set independently; and
restoring data received from the following CC through use of the control information received from the ordering CC.

7. The method as claimed in claim 6, wherein the subframe indicator indicates assignment of the at least one subframe of the following CC through use of bit value.

8. The method as claimed in claim 6, wherein the subframe indicator includes codeword related to index of a predetermined table, and the codeword indicates assignment of the at least one subframe of the following CC based on the subframe of the ordering CC that carries the control information.

9. The method as claimed in claim 6, wherein the subframe indicator includes predetermined number bits of a bitmap format, and each of the predetermined number bits indicates each assignment of the at least one subframe of the following CC.

10. The method as claimed in claim 6, wherein each of the at least subframe indicator is transmitted through a physical downlink control channel (PDCCH) and indicates a subframe of the following CC.

11. A base station (BS) in a time division duplex (TDD) system, the BS comprising:
a controller to perform controlling so as to set TDD configuration including at least one uplink (UL) and downlink (DL) subframe, the TDD configuration corresponding to an ordering component carrier (CC) and a following CC each is set independently; and
a transmitter to transmit control information to a user equipment (UE) on one subframe of the ordering CC, wherein the control information includes at least one subframe indicator indicating at least one subframe of the following CC, which includes data channel scheduled by the control information.

12. A user equipment (UE) in a time division duplex (TDD) system, the UE comprising:
a receiver to receive control information from a base station (BS) on one subframe of an ordering component carrier (CC), wherein the control information includes at least one subframe indicator indicating at least one subframe of a following CC, which includes data channel scheduled by the control information and TDD configuration of the ordering CC and the following CC including at least one uplink (UL) and downlink (DL) subframe is set independently; and
a controller to perform controlling so as to restore data received from the following CC through use of the control information received from the ordering CC.

13. A method of processing control information in a time division duplex (TDD) system, the method comprising the steps of:
receiving data from a base station(BS) on one subframe of a following component carrier (CC) among an ordering CC and the following CC, wherein TDD configuration of the ordering CC and the following CC including at least one uplink (UL) and downlink (DL) subframe each is set independently; and
restoring the data based on control information received through one previous subframe of the ordering CC when the control information indicating the one subframe of the following CC is not received through a subframe of the ordering CC corresponding to the same time.

14. A user equipment (UE) in a time division duplex (TDD) system, the UE comprising:
a receiver to receive data from a base station on one subframe of a following carrier (CC) among an ordering CC and the following CC, wherein TDD configuration of the ordering CC and the following CC including at least one uplink (UL) and downlink (DL) subframe each is set independently; and
a controller to perform controlling so as to restore the data based on control information received through one previous subframe of the ordering CC when the control information indicating the one subframe of the following CC is not received through a subframe of the ordering CC corresponding to the same time.
